(19) United States
(12) Patent Application Publication
(10) Pub. No.: US 2016/0337413 A1
(43) Pub. Date: Nov. 17, 2016

(54) CONDUCTING ONLINE MEETINGS USING NATURAL LANGUAGE PROCESSING FOR AUTOMATED CONTENT RETRIEVAL

(71) Applicant: Citrix Systems, Inc., Fort Lauderdale, FL (US)

(72) Inventor: Ahmed Said Sallam, Cupertino, CA (US)

(21) Appl. No.: 14/708,696

(22) Filed: May 11, 2015

(51) Int. Cl. H04L 29/06; H04L 29/08; G06F 17/30; G10L 25/63; G10L 17/00; G10L 15/30; H04L 12/58; G10L 15/18

(52) U.S. Cl. CPC H04L 65/1089; H04L 65/403; H04L 51/16; H04L 67/2804; G10L 15/1822; G10L 25/63; G10L 17/005; G10L 15/30; G06F 17/30684; G06F 17/30011

(57) ABSTRACT

A computer-implemented method of conducting an online meeting includes maintaining, by processing circuitry, an enterprise content management system storing metadata describing computer-renderable stored content items. The method further includes continually recognizing and analyzing, by the processing circuitry, speech of one or more participants in the online meeting to extract participant speech content. The method further includes continually searching the enterprise content management system using extracted participant speech content and the metadata to identify matching stored content items, and dynamically providing links or other controls to the participant during the online meeting to enable the participant to view and selectively share the matching stored content items in the online meeting.

### BACKGROUND

A typical web meeting shares visual content and audio content among multiple web meeting members. In particular, each web meeting member connects a respective user device to a central web meeting server over a computer network. Once the user devices of the web meeting members are connected with the central web meeting server, the members are able to watch visual content, as well as ask questions and inject comments to form a collaborative exchange even though the web meeting members may be scattered among different locations.

### SUMMARY

Systems and methods are disclosed in which intelligent personal assistance component based on natural language processing (NLP) is integrated into the delivery of online meetings. In particular, NLP is used to extract meaning from speech audio to identify topics, keywords, etc., and the extracted information is used to automatically identify and retrieve documents or other content items that may be relevant to an online meeting discussion. Such information can then be presented to participants as appropriate or as configured. The technique can make online meetings more productive and effective by enabling the online meeting system to proactively provide information relevant to the topics being discussed at the meeting.

In particular, a computer-implemented method is disclosed for conducting an online meeting. The method includes maintaining, by processing circuitry, an enterprise content management system storing content description information describing computer-renderable stored content items, such as documents, messages etc. as existing in an enterprise such as a corporation. The method further includes continually recognizing and analyzing, by the processing circuitry, speech of one or more participants in the online meeting to extract participant speech content. The method further includes continually searching the enterprise content management system using extracted participant speech content and the content description information to identify matching stored content items, and dynamically providing links or other controls to the participant during the online meeting to enable the participant to view and selectively share the matching stored content items in the online meeting.

In some arrangements, the content items include computer files and computer messages, and the content description information includes (1) information extracted from the content items, and (2) additional information added by a system administrator or tool, for use in matching and retrieving the content items based on the participant speech content. The description information may include a topic, keywords or phrases, importance/relevance information, confidentiality/sensitivity information, and access control information. In some arrangements, the computer files and computer messages are enterprise-owned documents stored in document sources of an enterprise, and the enterprise content management system includes content location information and external metadata, where the location information describes respective locations of the content items among the document sources, and the external metadata information containing contains associated with the content items in their respective document stores, the external metadata for a given content item including one or more of a title, data, subject, owner, sender and recipient of the content item.

In some arrangements, the recognizing and analyzing includes measuring speaker tone to estimate speaker emotion or intent and corresponding importance of information being conveyed by a speaker, the importance being used to indicate relative importance of corresponding retrieved content items. Estimated speaker emotion or intent may be used to display cues or visual feedback to a speaker and/or other participants in the online meeting. The measuring may be based on instant analysis and/or verified, trained and tuned, via (1) historical speech patterns recognized and verified with the user, or (2) individual user's training with various expressions and associated emotions.

In some arrangements, the recognizing and analyzing includes speaker recognition to biometrically identify participants for access control and/or other purposes.

In some arrangements, the speaking and analyzing may be performed by components of a speech analysis infrastructure (SAI) including (1) SAI agents executing on user devices, and (2) an SAI server in collaborative communication with the SAI agents.

In some arrangements, the enterprise content management system includes a document-to-recognized-speech matching engine providing matching intelligence between analyzed content from participant speech against analyzed content of stored content items.

In some arrangements, the method further includes system security enforcement by which (1) a system administrator specifies access and distribution rules for sharing and delivering content to meeting participants, and (2) the access and distribution rules are applied on the user devices.

In some arrangements, the method further includes visualization functionality by which end users and/or system administrators train and verify a speech analysis infrastructure for accurate recognizing and analyzing of meeting participants' speech.

Extracting of useful information using NLP as described herein can work in parallel with and applied to other forms of human communication: audio, instant messages, exchanged documents, etc. The information extraction process can be repeated based on the correlation and analysis of multiple analyzed streams of information.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a block diagram of a computer system;

FIG. 2 is a block diagram of a part of a computer system;

FIG. 3 is a block diagram of online meeting server equipment;

FIG. 4 is a block diagram of a user computing device;

FIG. 5 is a schematic diagram of an enterprise document management database;

FIG. 6 is schematic diagram of a speech analysis infrastructure (SAI) database;

FIG. 7 is a schematic diagram of a biometric matching infrastructure (BMI) database;

FIG. 8 is a flow diagram of operation of online meeting server equipment.

### DETAILED DESCRIPTION

An intelligent personal assistance component based on natural language processing is integrated into an online meeting system, such as a system called GoToMeeting® sold by Citrix Systems, Inc.

A recording of meeting participants' audio conversation is converted into textual content, then relevant information is extracted after content semantics analysis and used to identify and retrieve documents or other existing content that may be relevant. Such information can then be presented to participants as appropriate or as configured.

The technique can make online meetings more productive and effective by use of a feature that enables the meeting system to proactively provide information relevant to the topics being discussed at the meeting.

A knowledge expert data base system, referred to as a “content management system” herein, is established by indexing various sources of information including documents of all types available on users' devices, documents available on data sharing folders or systems such as ShareFile, DropBox, etc., documents available on private or public knowledge systems such as Wikipedia, email messages and other content, and other information. Documents may be classified with associated importance and relevance, which can be established based on usage/access, source of material (internal, partner, public internet, etc.), confidentiality and criticality, urgency, date, site location, etc.

Additionally, a meeting audio and/or video recording capability is augmented into each meeting session across all devices. A natural language processing (NLP) engine is used to:
Convert audio and video content into original textual and graphic content
Augment content using morphological and semantic analysis to understand intent, key words, key topics being stressed, importance to participants, etc.
Measure participants' response to utterances made by others.

A matching engine matches the data extracted by the NLP engine against the information available into the knowledge expert data base system to identify information relevant to each participant in the meeting.

A referral display component presents matching results from the matching engine visually to participants in ways that are appropriate to the types of devices and display media in use. This component is preferably integrated in some manner with the user interface of the online meeting application and provides mechanisms for participants to select content items and incorporate them into online meeting sessions, such as by opening windows that are also integrated with the online meeting application and can be placed into focus easily and quickly.

A configuration interface can be employed to enable system administrators and individual users to configure the system and provide it with information such as:
Identification of sources of information to gather and index (documents, emails, web links, etc.)
Access control and sharing properties and rules associated with those sources of information.

The NLP engine can include the ability to measure speaker tone to estimate intent, which can be based on instant analysis and/or verified, trained and tuned, via:
Historical speech patterns recognized and verified with the user.
Individual user's training with various expressions and associated emotions.

Speaker recognition is also utilized to automatically identify the person currently talking in the meeting. The identification can be used as a form of biometric identification used for access control and other purposes, e.g.:
Allowing the identified speaker to share certain documents during the meeting
Preventing certain meeting participant from viewing certain shared meeting through the meeting application.

Particular example uses include:
A participant is making a verbal reference to a corporate financial statement, and the system provides him/her with an immediate link to open and share the document through the meeting program interface.
A user is mentioning an email he/she sent to another person, and the system brings it up immediately.

The information processing and indexing could be done on user's devices, on corporate servers, or cloud servers. Distribution of processing may be based on various factors including:
Computational resources load and availability.
System configuration.
Information privacy and access rules.
Security compliance and governance policies.

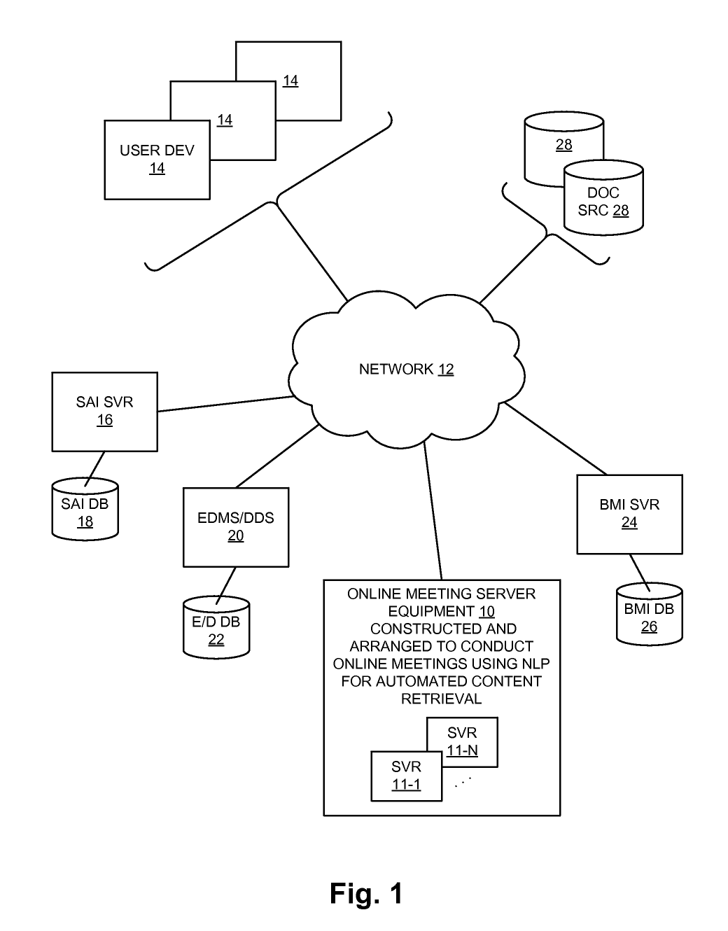

Turning now to the Figures, FIG. 1 shows a system in which online meetings or similar collaborative exchanges among system users are performed. The system includes online meeting server equipment 10 which is constructed and arranged to conduct online meetings with natural language processing for automated content retrieval as described herein. The online meeting server equipment 10, which generally includes one or more server computers (SVR) 11-1, 11-2 etc., is connected to a network 12 to which are also connected user devices 14.

As shown, the system may also include various additional servers and associated databases including:
Speech analysis infrastructure server (SAI SVR) 16 and associated SAI database (SAI DB) 18;
Enterprise document management system (EDMS) and directory database server (DDS) server 20 and associated EDMS/DDS database (E/D DB) 22;
Biometric matching infrastructure server (BMI SVR) 24 and associated BMI database (BMI DB) 26.

Also existing in the system are production subsystems that are the sources of documents and other content, shown as document sources 28. These are elaborated further below.

A user computing device, or user device, 14 is capable of executing application software such as the client side of an online meeting application. Thus a user device 14 has processing circuitry and memory storing such application software along with other software such as an operating system, device drivers, etc. Examples of computing devices 14 include a desktop or portable personal computer, tablet computer, smartphone, etc.

In operation, users participate in online meetings by establishing meeting sessions between their respective computing devices 14 and the online meeting server equipment 10. In conventional systems, online meetings include exchange of participants' audio (speech), video, and perhaps documents or other data items through use of a shared desktop or other sharing mechanism. From a technical perspective, in conventional systems there is no functional connection between the audio/video streams and user-controlled sharing (e.g., retrieval, manipulation and display) of documents. Users can speak/listen while also presenting/viewing documents, but the two separate activities are coordinated by the users themselves. As an example, if a certain topic arises in a meeting discussion (audio exchange), it is up to the users to recognize that a particular document is relevant and then take action to bring the document into the online meeting, such as by opening the document into a system window using a file browser and then sharing the system window in the online meeting session.

In the illustrated system online meetings are enhanced by use of natural language processing (NLP, also referred to as “speech recognition”) of the audio streams and using recognized terms to automatically retrieve content that may be relevant to a discussion. An identification of retrieved content is presented to one or more participants in some manner, such as by presentation of icons with content titles or other descriptive information, and a user interface provides a mechanism for participants to easily incorporate the retrieved content into an ongoing online meeting. These features can make online meetings both more productive (less user effort involved in retrieving desired content) and more effective (richer use of content due to greater ease of accessing and incorporating it).

More specifically, operation involves two key phases or components. One is regular background processing of enterprise content from the sources 28 by the EDMS/DDS server 20 to populate the EDMS/DDS database 22 with information describing available documents and other content items. This information is populated and structured to facilitate operation of the second phase, which is real-time processing during online meetings to (1) use NLP to extract keywords, topics and other features of a discussion, (2) match the extracted information with the descriptive information in the EDMS/DDS database 22 to identify relevant content existing on the sources 28, and (3) retrieve the identified content and make it available to participants in the online meeting. These two phases of operation are described more fully below.

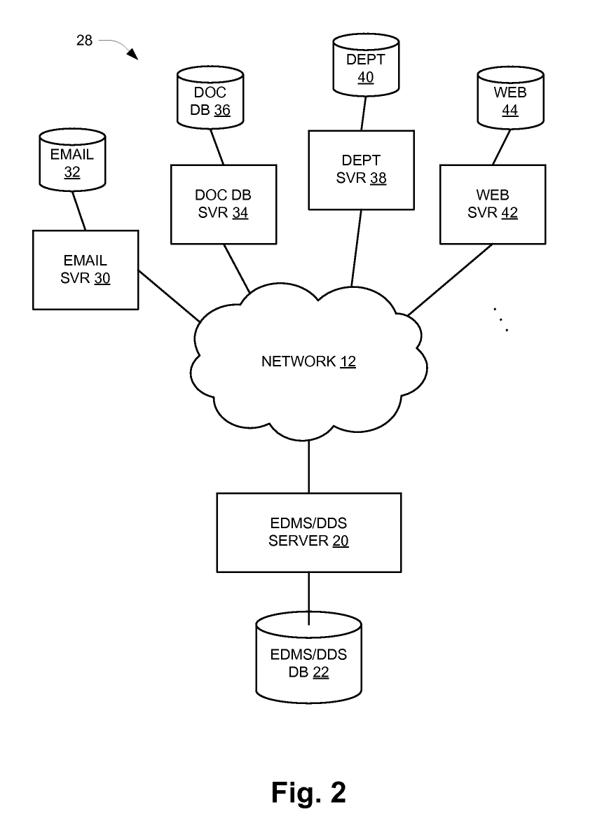

FIG. 2 illustrates various example document sources 28 that may reside in or otherwise be accessible to an enterprise. Only one of each type is shown, but it will be appreciated that in general there may be multiple instances of selected types in an organization. Example sources 28 include an email server 30 and associated email store 32; a document database server 34 and associated document database 36; a department server 38 and associated department store 40; and a web server 42 and associated web site store 44. The web server 42 may be hosting a so-called “intranet”, i.e., a private network using Internet and Web technology serving as an internal distributed knowledge base. Other types of document sources 28 are of course possible.

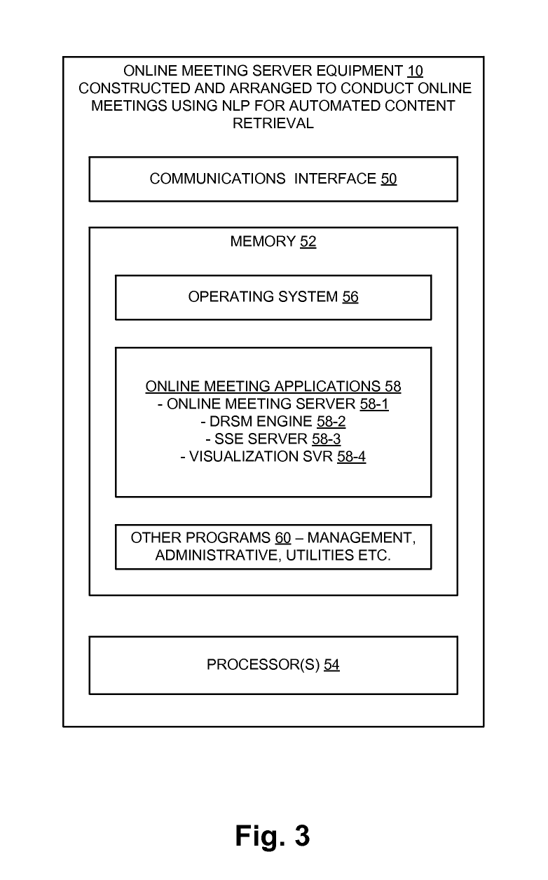

FIG. 3 shows the online meeting server equipment 10. It is typically realized by one or more computers, e.g., server computers 11 (FIG. 1), which may be located in a corporate data center, web farm, cloud computing facility(ies), or some mixture thereof. The equipment includes a communications interface 50, memory 52 and processor(s) 54. The memory 52 and processors 54 collectively form processing circuitry that executes application software and other computer program instructions to realize functionality as described herein. The communications interface 50 provides connections to the network 12 and perhaps other external systems or devices, such as locally attached secondary storage (not shown) for example.

As shown, the memory 52 stores software including an operating system 56 and online meeting applications 58 that are executed by the processors 54. The online meeting applications 58 include an online meeting server 58-1 that provides the core online meeting experience, i.e., receiving, mixing and distributing audio and video, presenting control and monitoring interfaces to participants, etc. The online meeting applications 58 also include applications that contribute to the NLP-based automated document retrieval described herein. These includes a document-to-recognized-speech matching (DRSM) engine 58-2, a system security enforcer (SSE) server 58-3, and a visualization server (SVR) 58-4.

The DRSM engine 58-2 provides all matching intelligence between the analyzed content from meetings' recordings and audio against the analyzed content of the enterprise documents. The DRSM engine 58-2 works closely with the EDMS/DDS server 20 and the SAI server 16 to provide this capability.

The SSE server 58-3 allows a system administrator to specify access and distribution rules for sharing and delivering content to meeting participants. The SSE server 58-3 works in collaboration with security access (SA) agents that reside on the user devices 14 to apply access control policy and rules as provided by system administrators.

The visualization server 58-4 allows end users and system administrators to train and verify the speech analysis infrastructure as implemented by the SAI server 16 and associated agents on the user devices 14 (see below).

As also shown in FIG. 3, the memory 52 may also store other programs 60 such as management or administrative applications, utilities, etc. A management server can provide graphical and scripting user interfaces (UIs) to system administrators to configure system operations and query primitive and aggregated events. In some embodiments, the visualization server 58-4 may be included among the other programs 60 rather than within the online meeting applications 58.

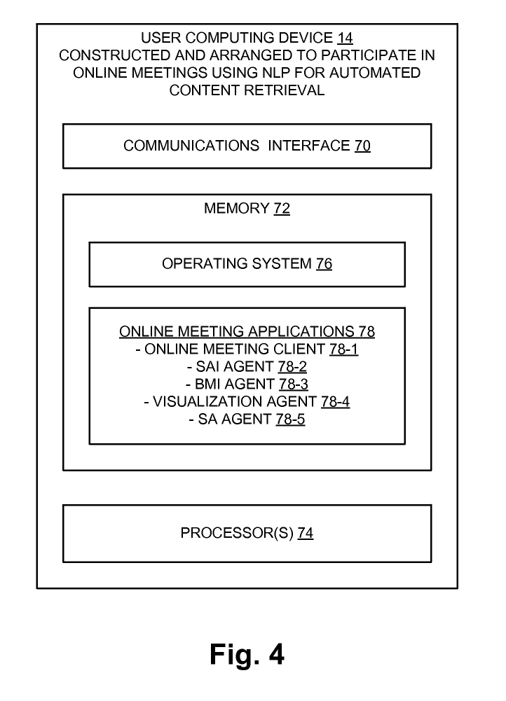

FIG. 4 shows a user device 14. As mentioned above, it is typically a personal computing device such as a personal computer, tablet computer, etc. It may have a fixed location, such as a user's home or office, or it may be a mobile device. The user device 14 includes a communications interface 70, memory 72 and processor(s) 74. The memory 72 and processors 74 collectively form processing circuitry that executes application software and other computer program instructions to realize functionality as described herein. The communications interface 70 provides connections to the network 12 and perhaps other external systems or devices.

As shown, the memory 72 stores software including an operating system 76 and online meeting applications 78 that are executed by the processors 74. The online meeting applications 78 include an online meeting client 78-1 that works with the online meeting server 58-1 of the online meeting server equipment 10 to provide the core online meeting experience to the local user, i.e., forwarding locally captured audio and video to the online meeting server equipment 10 and receiving and rendering mixed audio and video that is generated by the online meeting server equipment 10 and distributed to the participants. The online meeting applications 78 also include an SAI agent 78-2 and a BMI agent 78-3 that work together with the SAI server 16 and BMI server 24 respectively to provide speech analysis functionality and biometric matching functionality. Also shown are a visualization agent 78-4 and security access (SA) agent 78-5. The SA agent 78-5 works in conjunction with the SSE server 58-3 to obtain and apply access control policy and rules as provided by system administrators. The visualization agent 78-4 works in conjunction with the visualization server 58-4 to train and verify the speech analysis infrastructure.

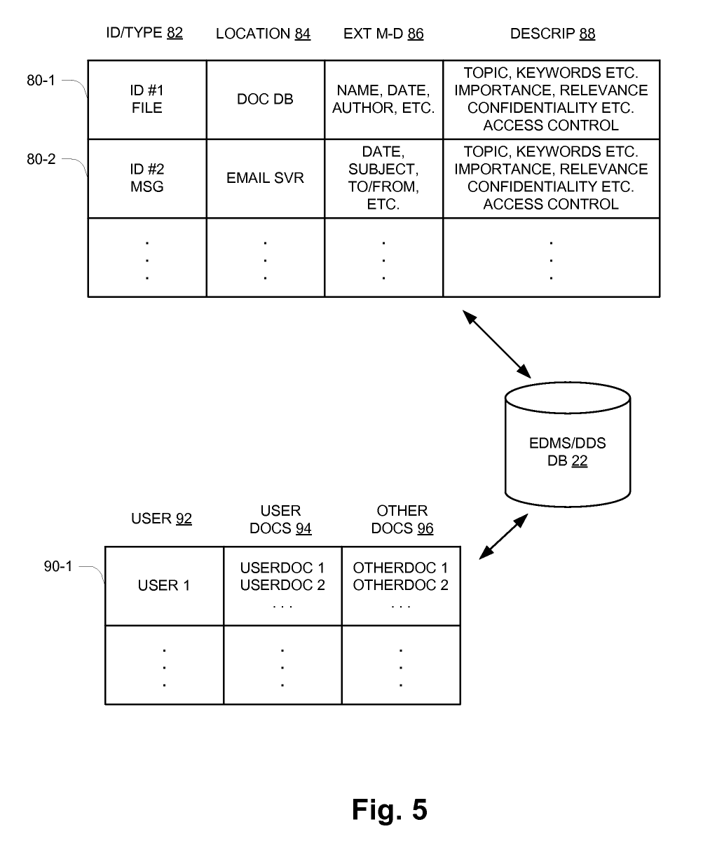

FIG. 5 illustrates contents of the EDMS/DDS database 22 of FIG. 1. It includes EDMS records 80 (80-1, 80-2, etc.) for respective documents or content items located on the document sources 28, as well as DDS records 90 (90-1, etc.) for respective system users who either own and control content items or have been granted access to content items owned and controlled by other system users. Each EDMS record 80 includes an ID/Type field 82, location field 84, external metadata (EXT M-D) field 86, and description (DESCRIP) field 88. For each record 80, the ID/Type field 82 includes a unique identifier for a content item and a description of its type, e.g., file, email message (MSG), etc. The location field 84 describes where the content item is located among the document sources 28, e.g., in the document database 36, email store 32, etc. The external metadata field 86 contains relevant metadata associated with the content item in its document store 28. For a file, the external metadata 86 may include a file name, date (creation/edited), owner/author, etc. For an email message, the external metadata 86 may include a date, subject, sender and recipient(s) (TO/FROM), etc. The description field 88 includes useful information extracted from the content item by the EDMS/DDS server 20 for use in matching and retrieving the content item based on analyzed speech in a meeting session. It may also include additional information added by a system administrator or an automated tool. Example description information 88 includes a topic, keywords or phrases, importance/relevance, confidentiality and sensitivity, and access control information.

The DDS records 90 are maintained and used by a DDS server component of the EDMS/DDS server 20 to host a list of enterprise users (e.g., employees, contractors, etc.) along with identifications of documents and other content items (1) they have authored and have ownership/control over, and (2) they have been granted access to by other users having ownership/control thereof. Each DDS record 90 corresponds to a particular user and includes a user field 92, user documents (DOCS) field 94, and other documents field 96. The user field 92 identifies an associated user. The user documents field 94 identifies the documents and other content items under the ownership/control of this user, while the other documents field 96 identifies the documents and other content items under the ownership/control of other users that this user has been granted access to.

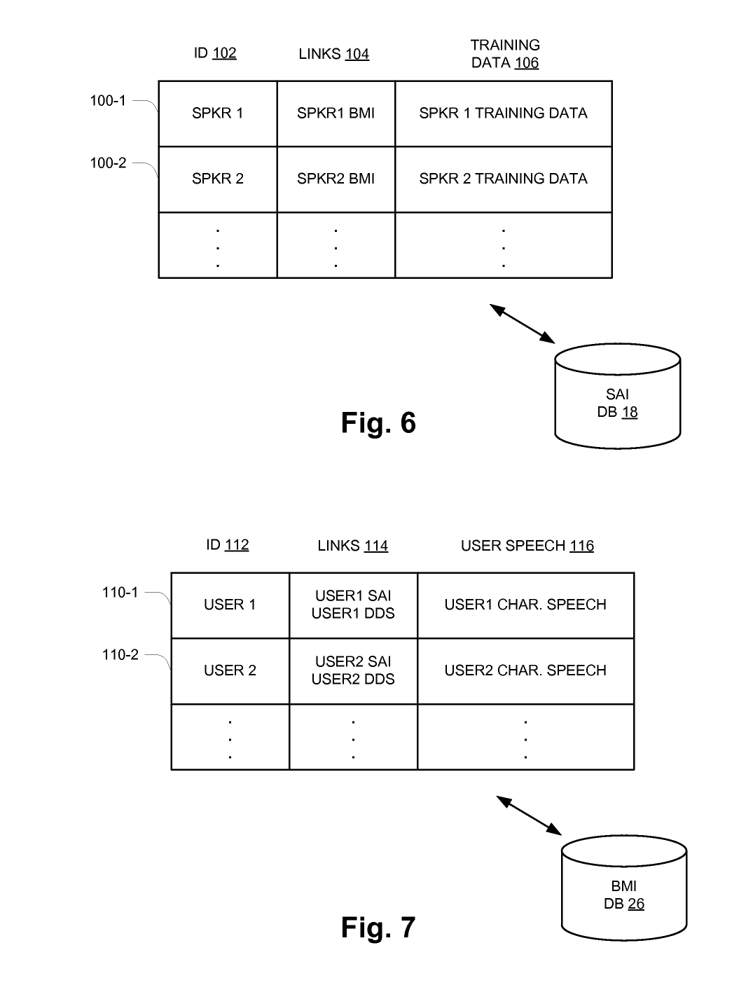

FIG. 6 illustrates contents of the SAI database 18 of FIG. 1. It includes records 100 for respective identified speakers (SPKR) using the online meeting system. In general, most or all speakers will also be registered as users of the system, but the more general term “speaker” allows for incomplete overlap between these two sets. As shown, each record 100 includes an identifier (ID) field 102, links field 104, and training data field 106. The identifier field 102 stores a unique identifier of an individual speaker. The links field 104 stores one or more references or links to BMI data for this speaker stored as part of the BMI database 26. Linking of records enables the two servers (SAI server 16 and BMI server 24) to collaborate in the biometric matching process in particular. The training data field 106 stores data that customizes the application of speech recognition to this user, as generated as part of explicit or implicit training operation.

FIG. 7 illustrates contents of the BMI database 26 of FIG. 1. It includes records 110 for respective users of the online meeting system. As shown, each record 110 includes an identifier (ID) field 112, links field 114, and user speech field 116. The identifier field 112 stores a unique identifier of an individual user. The links field 114 stores references or links to SAI data for this user stored as part of the SAI database 18, as well as DDS data for this user stored as part of the EDMS/DDS database 22. Linking of records enables the servers (BMI server 24, SAI server 16 and EDMS/DDS server 20) to collaborate in the biometric matching process. The user speech field 116 stores samples of speech of this user than are used in the biometric matching process.

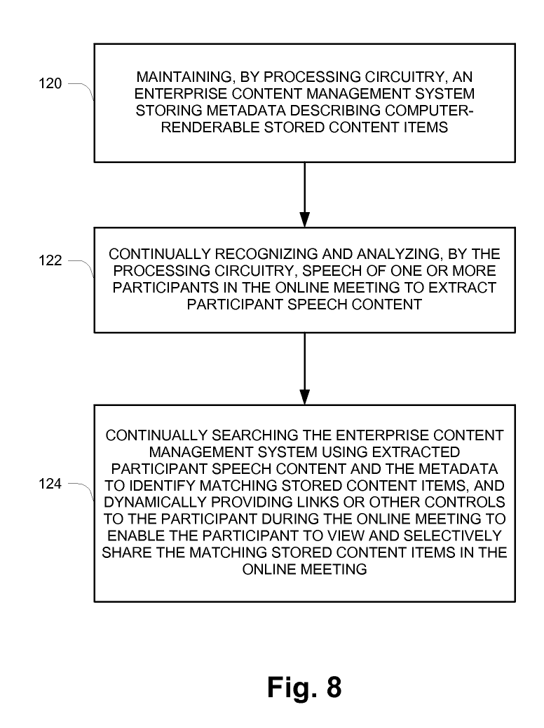

FIG. 8 illustrates operation at a high level of a computer-implemented method of conducting an online meeting.

At 120, operation includes maintaining, by processing circuitry, an enterprise content management system storing metadata describing computer-renderable stored content items. In one embodiment the enterprise content management system is realized by the EDMS/DDS server 20 and EDMS/DDS database 22, used in conjunction with the document sources 28 storing the content items. As outlined above, the processing circuitry includes hardware processing elements (processors, memory, etc.) of one or more server computers executing application program(s).

At 122, operation includes continually recognizing and analyzing, by the processing circuitry, speech of one or more participants in the online meeting to extract participant speech content. In one embodiment, this operation is performed by the SAI agents 78-2 of the user devices 14 in conjunction with the SAI server 16 and SAI database 18.

At 124, operation includes continually searching the enterprise content management system using extracted participant speech content and the metadata to identify matching stored content items, and dynamically providing links or other controls to the participant during the online meeting to enable the participant to view and selectively share the matching stored content items in the online meeting. In one embodiment this operation is performed in large part by the DRSM engine 58-2 as well as the online meeting server 58-1 and online meeting client 78, which together provide business logic and user interface infrastructure for presenting content items to participants along with controls for incorporating the content items into an online meeting.

While various embodiments of the invention have been particularly shown and described, it will be understood by those skilled in the art that various changes in form and details may be made therein without departing from the spirit and scope of the invention as defined by the appended claims.

What is claimed is:

1. A computer-implemented method of conducting an online meeting, comprising:
maintaining, by processing circuitry, an enterprise content management system storing content description information describing computer-renderable stored content items;
continually recognizing and analyzing, by the processing circuitry, speech of one or more participants in the online meeting to extract participant speech content;
continually searching the enterprise content management system using extracted participant speech content and the content description information to identify matching stored content items, and dynamically providing links or other controls to the participant during the online meeting to enable the participant to view and selectively share the matching stored content items in the online meeting.

2. The computer-implemented method of claim 1, wherein the content items include computer files and computer messages, and wherein the content description information includes (1) information extracted from the content items, and (2) additional information added by a system administrator or tool, for use in matching and retrieving the content items based on the participant speech content.

3. The computer-implemented method of claim 2, wherein the description information includes a topic, keywords or phrases, importance/relevance information, confidentiality/sensitivity information, and access control information.

4. The computer-implemented method of claim 2, wherein the computer files and computer messages are enterprise-owned documents stored in document sources of an enterprise, and wherein the enterprise content management system includes content location information and external metadata, the location information describing respective locations of the content items among the document sources, the external metadata information containing metadata associated with the content items in their respective document stores, the external metadata for a given content item including one or more of a title, data, subject, owner, sender and recipient of the content item.

5. The computer-implemented method of claim 1, wherein the recognizing and analyzing includes measuring speaker tone to estimate speaker emotion or intent and corresponding importance of information being conveyed by a speaker, the importance being used to indicate relative importance of corresponding retrieved content items.

6. The computer-implemented method of claim 5, wherein estimated speaker emotion or intent is used to display cues or visual feedback to a speaker and/or other participants in the online meeting.

7. The computer-implemented method of claim 5, wherein the measuring is based on instant analysis and/or verified, trained and tuned, via (1) historical speech patterns recognized and verified with the user, or (2) individual user's training with various expressions and associated emotions.

8. The computer-implemented method of claim 1, wherein the recognizing and analyzing includes speaker recognition to biometrically identify participants for access control and/or other purposes.

9. The computer-implemented method of claim 1, wherein the speaking and analyzing is performed by components of a speech analysis infrastructure (SAI) including (1) SAI agents executing on user devices, and (2) an SAI server in collaborative communication with the SAI agents.

10. The computer-implemented method of claim 1, wherein the enterprise content management system includes a document-to-recognized-speech matching engine providing matching intelligence between analyzed content from participant speech against analyzed content of stored content items.

11. The computer-implemented method of claim 1, further including system security enforcement by which (1) a system administrator specifies access and distribution rules for sharing and delivering content to meeting participants, and (2) the access and distribution rules are applied on the user devices.

12. The computer-implemented method of claim 1, further including visualization functionality by which end users and/or system administrators train and verify a speech analysis infrastructure for accurate recognizing and analyzing of meeting participants' speech.

13. Online meeting server equipment, comprising:
a communications interface;
memory;
storage; and
one or more processors coupled to the communications interface, memory and storage, wherein the memory stores computer program instructions executed by the processors to form processing circuitry causing the online meeting server equipment to perform a method of conducting an online meeting, the method including:
maintaining, by processing circuitry, an enterprise content management system storing content description information describing computer-renderable stored content items;
continually recognizing and analyzing, by the processing circuitry, speech of one or more participants in the online meeting to extract participant speech content;
continually searching the enterprise content management system using extracted participant speech content and the content description information to identify matching stored content items, and dynamically providing links or other controls to the participant during the online meeting to enable the participant to view and selectively share the matching stored content items in the online meeting.

14. The online meeting server equipment of claim 13, wherein the content items include computer files and computer messages, and wherein the content description information includes (1) information extracted from the content items, and (2) additional information added by a system administrator or tool, for use in matching and retrieving the content items based on the participant speech content.

15. The online meeting server equipment of claim 14, wherein the description information includes a topic, keywords or phrases, importance/relevance information, confidentiality/sensitivity information, and access control information.

16. The online meeting server equipment of claim 14, wherein the computer files and computer messages are enterprise-owned documents stored in document sources of an enterprise, and wherein the enterprise content management system includes content location information and external metadata, the location information describing respective locations of the content items among the document sources, the external metadata information containing metadata associated with the content items in their respective document stores, the external metadata for a given content item including one or more of a title, data, subject, owner, sender and recipient of the content item.

17. The online meeting server equipment of claim 13, wherein the recognizing and analyzing includes measuring speaker tone to estimate speaker emotion or intent and corresponding importance of information being conveyed by a speaker, the importance being used to indicate relative importance of corresponding retrieved content items.

18. The online meeting server equipment of claim 17, wherein estimated speaker emotion or intent is used to display cues or visual feedback to a speaker and/or other participants in the online meeting.

19. The online meeting server equipment of claim 17, wherein the measuring is based on instant analysis and/or verified, trained and tuned, via (1) historical speech patterns recognized and verified with the user, or (2) individual user's training with various expressions and associated emotions.

20. A computer program product having a non-transitory computer-readable medium storing a set of computer program instructions, the computer program instructions being executable by processing circuitry of online meeting server equipment to cause the online meeting server equipment to conduct online meetings, by:
maintaining, by processing circuitry, an enterprise content management system storing content description information describing computer-renderable stored content items;
continually recognizing and analyzing, by the processing circuitry, speech of one or more participants in the online meeting to extract participant speech content;
continually searching the enterprise content management system using extracted participant speech content and the content description information to identify matching stored content items, and dynamically providing links or other controls to the participant during the online meeting to enable the participant to view and selectively share the matching stored content items in the online meeting.
